(19) United States
(12) Patent Application Publication
(10) Pub. No.: US 2025/0056352 A1
(43) Pub. Date: Feb. 13, 2025

(54) ENHANCED UPLINK SWITCHING FOR MULTI-RECEIVER USER EQUIPMENT AT BEAM FAILURE

(71) Applicant: Nokia Technologies Oy, Espoo (FI)

(72) Inventors: Dimitri GOLD, Espoo (FI); Rafael CAUDURO DIAS DE PAIVA, Aalborg (DK); Giang NGUYEN, Oulu (FI); Riikka Karoliina DIMNIK, Espoo (FI)

(21) Appl. No.: 18/791,735

(22) Filed: Aug. 1, 2024

Related U.S. Application Data
(60) Provisional application No. 63/518,940, filed on Aug. 11, 2023.

(51) Int. Cl. H04W 36/08; H04B 7/06; H04W 36/30

(52) U.S. Cl. CPC H04W 36/08; H04B 7/06964; H04W 36/305

(57) ABSTRACT

A method is provided that includes monitoring a radio link quality at a user equipment connected to both a first transmission-reception point (TRP) and a second TRP of a network. The user equipment having a first downlink (DL) connection and a second DL connection with respectively the first TRP and the second TRP, but an uplink (UL) connection with with the second TRP but not the first TRP, and the radio link quality monitored is of the second DL connection with the second TRP. The method includes identifying a condition for switching the UL connection, based on at least the radio link quality of the second DL connection, and switching the UL connection from the second TRP to the first TRP, based on the determination.

### TECHNOLOGICAL FIELD

The present disclosure relates generally to telecommunications and, in particular, to preventing or responding to uplink beam failure in for multi-receiver user equipment in a telecommunications system.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how that should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

### BRIEF SUMMARY

Example implementations of the present disclosure are directed to telecommunications and, in particular, to preventing or responding to uplink beam failure in for multi-receiver user equipment in a telecommunications system. In this regard, the present disclosure includes, without limitation, the following example implementations.

Some example implementations provide a method comprising: monitoring a radio link quality at a user equipment connected to both a first transmission-reception point (TRP) and a second TRP of a network, the user equipment having a first downlink (DL) connection and a second DL connection with respectively the first TRP and the second TRP, but an uplink (UL) connection with with the second TRP but not the first TRP, the radio link quality monitored being of the second DL connection with the second TRP; identifying a condition for switching the UL connection, based on at least the radio link quality of the second DL connection; and switching the UL connection from the second TRP to the first TRP, based on the determination.

Some example implementations provide a method comprising: collecting operational information at a network including to a first transmission-reception point (TRP) and a second TRP, the operational information including information relating to one or more of the first TRP, the second TRP, or a user equipment connected to both the first TRP and the second TRP, the user equipment having a first downlink (DL) connection and a second DL connection with respectively the first TRP and the second TRP, but an uplink (UL) connection with with the second TRP but not the first TRP; performing an evaluation of the operational information for potential UL failure at either of the first TRP or the second TRP; and making a determination, at the network, whether or not to switch the UL connection from the second TRP to the first TRP, based on the evaluation.

Some example implementations provide a method comprising: detecting a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the second DL connection with the second TRP; performing an evaluation of a UL condition of the first TRP; making a determination to switch the UL connection from the second TRP to the first TRP or a third TRP, based on the evaluation; and switching the UL connection from the second TRP to the first TRP or the third TRP, based on the determination.

Some example implementations provide a method comprising: detecting a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the first DL connection with the first TRP; evaluating a difference in propagation delay between the first TRP and the second TRP; making a determination whether to perform a beam recovery procedure to recover the first DL connection, with the first TRP or through the UL connection with the second TRP, based on the difference in propagation delay; and performing the beam recovery procedure based on the determination.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a deployment of a PLMN, according to some example implementations;

FIG. 3 illustrates an example of multi-TRP (transmission-reception point) communication, according to some example implementations;

FIG. 4 shows a high speed train (HST) scenario in which beam failure potential may be addressed, according to some example implementations;

FIG. 5 illustrates a plot of reference signal received power (RSRP) versus distance along the HST rail track to show where a potential for link failure exists which can be addressed by some example implementations;

FIG. 6 is a signaling chart for preventing uplink (UL) interruption, according to some example implementations;

FIG. 7 is a signaling chart for preventing UL interruption, using experience-based information from the network side to anticipate a potential need for UL switching, according to some example implementations;

FIGS. 8A and 8B is a signaling chart for responding to a beam failure by autonomously adjusting UL transmit timing, according to some example implementations;

FIG. 9 is a signaling chart for recovering a downlink (DL) connection with one TRP, using a UL connection with another TRP, according to some example implementations;

FIGS. 10A and 10B are flowcharts illustrating various steps in a method, according to various example implementations;

FIGS. 11A and 11B are flowcharts illustrating various steps in another method, according to various example implementations;

FIGS. 12A, 12B, 12C, 12D and 12E are flowcharts illustrating various steps in another method, according to various example implementations;

FIGS. 13A and 13B are flowcharts illustrating various steps in yet another method, according to various example implementations; and

FIG. 14 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced and 5G NR; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

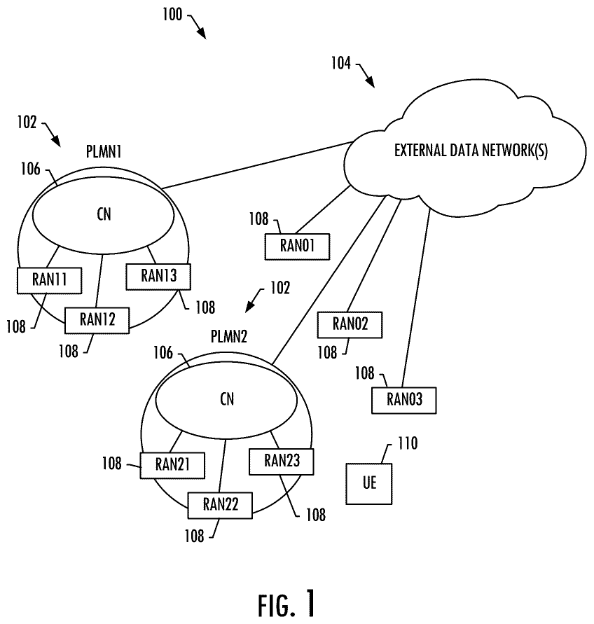

FIG. 1 illustrates a telecommunications system 100 according to various example implementations of the present disclosure. The telecommunications system generally includes one or more telecommunications networks. As shown, for example, the system includes one or more public land mobile networks (PLMNs) 102 coupled to one or more other external data networks 104—notably including a wide area network (WAN) such as the Internet. Each of the PLMNs includes a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system includes one or more radio units that may be varyingly known as user equipment (UE) 110, terminal device, terminal equipment, mobile station or the like. The UE is generally a device configured to communicate with a network device or a further UE in a telecommunication network. The UE may be a portable computer (e.g., laptop, notebook, tablet computer), mobile phone (e.g., cell phone, smartphone), wearable computer (e.g., smartwatch), or the like. In other examples, the UE may be customer premises equipment (CPE). In yet other examples, the UE may be an Internet of things (IoT) device, an industrial IoT (IIoT device), a vehicle equipped with a vehicle-to-everything (V2X) communication technology, or the like.

In operation, a UE 110 may be configured to connect to one or more RANs 108 according to their particular radio access technologies to thereby access a particular CN 106 of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIT).

Examples of radio access technologies include 3GPP radio access technologies such as GSM, UMTS, LTE, LTE Advanced, and 5G NR. Other examples of radio access technologies include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G or higher generation mobile communication technology and their different versions, as well as to any other wireless radio access technology that may be arranged to interwork with such a mobile communication technology to provide access to the core network of a mobile network operator (MNO).

In various example, the RAN 108 may be configured as one or more macrocells, microcells, picocells, femtocells or the like. The RAN may generally include one or more radio access nodes that are configured to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), next generation eNB (ng-eNB), or the like. Some type of network controlling/governing entity responsible for control of the radio access nodes. The network controlling/governing entity and radio access node may be separate or integrated into a single apparatus. The network controlling/governing entity may include processing circuitry configured to carry out various management functions, etc. The processing circuitry may be associated with a computer-readable storage medium or database for maintaining information required in the management functions.

A RAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly including radio links. The RAN may be connected to a CN 106 through one or more gateways, network functions or the like.

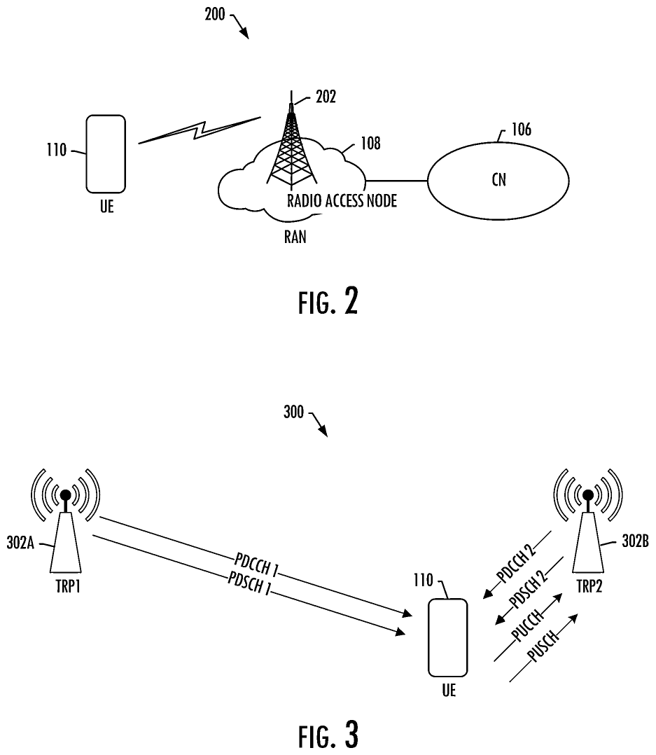

As will be appreciated, a PLMN 102 may be deployed in a number of different manners. FIG. 2 illustrates a deployment 200 of a PLMN, such as a 4G LTE or 5G deployment, according to some example implementations. As shown, the deployment includes a CN 106, and RAN 108 with one or more radio access nodes 202 configured to interact with UEs 110. In a 4G LTE deployment, the EPC is the CN, and the evolved UMTS terrestrial radio access network (E-UTRAN) is the RAN; and the E-UTRAN includes one or more eNBs (radio access nodes) configured connect UEs to the E-UTRAN to thereby access the EPC. Similarly, in a 5G deployment, the 5GC is the CN 106, and the next generation (NG) radio access network (NG-RAN) is the RAN 108; and the NG-RAN includes one or more gNBs (radio access nodes 202) configured connect UEs 110 to the NG-RAN to thereby access the 5GC. The term ‘gNB’ in 5G may correspond to the eNB in 4G LTE.

Some deployments of 4G LTE and 5G in particular are considered standalone (SA) deployments. Other deployments combine 4G LTE and 5G technologies, and are referred to as non-standalone (NSA) deployments. In some deployments, the E-UTRAN includes one or more ng-eNBs that are configured to communicate with the 5GC, and that may also be configured to communicate with one or more gNBs. Similarly, in another deployment, the NG-RAN may include one or more en-gNBs that are configured to communicate with the EPC, and that may also be configured to communicate with one or more eNBs. In various instances, a single UE 110, a dual-mode or multimode UE, may support multiple (two or more) RANs-thereby being configured to connect to multiple RANs, such as 4G LTE and 5G.

In some deployments, operations of a radio access node 202 may be distributed or functionally split into components including one or more remote radio head (RRHs) or radio units (RUs), and a baseband unit (BBU); and in some architectures, the BBU may be split into a distributed unit (DU) and a central/centralized unit (CU), such as a server, host or node. In some architectures, the RRH/RU and DU may be collocated. It is also possible that node operations may be distributed among a plurality of servers, hosts or nodes.

It should also be understood that the distribution of work between CN 106 operations and radio access node 202 operations may vary depending on implementation. Thus, a 5G network architecture may be based on a so-called CU-DU split. One gNB-CU (central node) may control one or more gNB-DUs. The gNB-CU may control a plurality of spatially separated gNB-DUs, acting at least as transmit/receive (Tx/Rx) nodes. In some example implementations, however, the gNB-DUs (also called DU) may include, for example, a radio link control (RLC), medium access control (MAC) layer and a physical (PHY) layer, whereas the gNB-CU (also called a CU) may include the layers above the RLC layer, such as a packet data convergence protocol (PDCP) layer, a radio resource control (RRC), and an internet protocol (IP) layer. Other functional splits are also possible. It is considered that skilled person is familiar with the OSI model and the functionalities within each layer.

In some example implementations, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU, and the boundary where the responsibility is shifted between the CU and the DU may be selected according to implementation.

In various instances, a UE 110 may be configured to operate using multiple antenna panels or beams, such as via multiple input, multiple output (MIMO) technology, which may allow the UE to dramatically increase its data rate capabilities. One feature related to this capability is referred to as multi-TRP (transmission-reception point). This feature enables the network to use multiple TRPs to communicate with a UE. In this regard, a TRP may be a set of geographically collocated antennas supporting transmission point (TP) and/or reception point (RP) functionality. In various examples, TRPs may include radio access nodes 202, radio access node antennas, RRHs, RHs, a remote antenna of a radio access node, or the like.

Related to multi-TRP communication, radio link monitoring and link recovery procedures have been defined to address situations in which a beam failure (BF) occurs between the UE and a TRP. These procedures include TRP-specific link recovery to cover a scenario where a UE is capable of simultaneously receiving from two TRPs. TRP-specific link recovery may be more specific for a multi-DCI scenario in which, on the downlink (DL), the physical downlink control channel (PDCCH) is configured to be transmitted from both TRPs, and the physical downlink shared channel (PDSCH) is scheduled on each link with separate downlink control information (DCI). But not all UEs support two simultaneous uplink connections, making it only possible for the UE to have single uplink (UL) transmission towards a single TRP. A UE with multi-DCI (mDCI) configured may be connected to two TRPs in the DL.

FIG. 3 illustrates an example of multi-TRP communication 300, according to some example implementations. More particularly, FIG. 3 illustrates a UE 110 connected to a first TRP (TRP1) 302A and a second TRP (TRP2) 302B, which may be radio access nodes 202 or TRPs of a radio access node. As shown, TRP2 (an “anchor” TRP) may have both UL and DL connections to the UE 110, whereas TRP1 (a “secondary” TRP) has only a DL connection. In the illustrated example, DL connections are shown as including the PDCCH and PDSCH, and the UL connection is shown as including a physical uplink control channel (PUCCH) and a physical uplink shared channel (PUSCH). The UL and DL connections between the UE and TRP2 include a PDCCH2 (with coresetpoolindex0), PDSCH2, PUSCH, PUCCH; and the DL connections between the UE and TRP1 include a PDCCH1 (with coresetpoolindex1) and PDSCH1.

Although the example illustrates two TRPs, it should be understood that some examples may involve more than two TRPs and more than one UL connection. For example, the UE may be connected to three TRPs in DL, and only two of the three TRPs in the UL. It should also be understood that although the TRPs may be of the same cell, in some examples, the TRPs may be of different cells.

In TRP-specific beam failure and recovery, if beam recovery procedure is triggered for either of the TRPs, a UE 110 provided with a configuration of PUCCH transmission with link recovery request (LRR) resources may transmit a scheduling request (SR) for a UL resource, followed by a MAC control element (CE) providing the beam index for the corresponding TRP experiencing the beam failure. This MAC CE may at times be referred to as a beam failure recovery (BFR) MAC CE. For the UE not provided with a configuration of PUCCH transmission with LRR resources, the UE may transmit a random access (RA) preamble for UL shared channel (SCH) resource application, followed by a MAC CE providing the beam index for the corresponding TRP experiencing the failure.

In certain contexts, TRP-specific beam failure and recovery may be complicated, such as when the UE 110 is moving at a high rate of speed relative to the TRPs 302A, 302B. Some unique situations may be encountered, for example, in a high speed train (HST) deployment that employs millimeter wave frequencies, such as in frequency range 2 (FR2). In this regard, a power class 6 (PC6) UE (designed specifically for HST FR2 deployments) may be installed on the roof top of a train in order to preserve line-of-sight (LoS) conditions. Due to high path loss at higher carrier frequencies, and due to a need to achieve longer inter-site distances (ISD) along the railway track, beamforming may be used at both the TRP side and the UE side. Beam management including beam failure detection (BFD) and BFR may therefore be particularly useful in this context, as well as other high speed mobility contexts.

In order to simplify mobility at high speed, it may be assumed in HST FR2 deployments that a cell can be constituted from multiple non-collocated TRPs that may possess the same physical cell identifier (PCI). Mobility of a UE 110 between the TRPs may be performed with a beam change (e.g., transmission configuration indicator (TCI) state switch for DL, and spatial relation switch for UL). Handover (HO) of the UE may be used to change from one cell to another. The typical distance between non-collocated TRPs may be on the order of 700 meters.

Although work on HST deployment continues, the UE 110 may still only support a single UL connection. The UE may therefore have two antenna panels to connect to TRP1 302A and TRP2 302B on the DL side, only one of the antenna panels may be used to connect to TRP2 on the UL side. In some HST deployments, such as those in which the rail track runs through a tunnel, the TRPs may be located very close to the track, presenting an environment even more challenging. The issue of supporting UL switching with large propagation delay differences in case of beam failure in a multi-TRP scenario comes into focus. And while UL switching according to example implementations of the present disclosure may provide improved performance in many situations, the challenges associated with high speed mobility may particularly benefit.

Given the situation as described above, it can be appreciated that timely switching of the UL from TRP2 302B to TRP1 302A may be helpful in relation to maintaining continuous UL connection of the UE 110. However, in rapidly changing radio conditions, such as in FR2 or especially HST FR2 scenarios, traditional UE measurement, reporting and spatial relation/UL or joint TCI state/UL beam switch indication generated by procedures executed by the network (e.g., radio access node 202 of RAN 108) might be too slow to permit continuity. For example, the UE might already observe degradation of channel conditions on one of the TRP-specific links or compare internally two TRP links and select the preferred one for UL transmission, but it may still take substantial time before the network provides an indication to direct a change of the UL link from TRP2 to TRP1.

Thereafter, if beam failure happens, it cannot be guaranteed that a recovery beam can be found in the set of BFD/BFR resources that are typically provided to the UE 110 for TRP2 302B that experienced the failure. On the other hand, the TRP1 302A might still have a reliable connection, and can be used both for UL and DL before a new TRP is identified for recovery. Additionally, if beam recovery assumes the transmission of a SR in LRR resources provided to the UE (without a RA preamble), there is no guarantee that either the network or TRP1 can receive the SR because UL transmit timing of the UE might not be adjusted for TRP1. Such a situation may delay link/beam recovery in connection with three possible failure modes.

In one failure case, there may be a failure on both TRP1 302A and TRP2 302B. In this failure case, current requirements designate that the UE 110 triggers beam failure recovery by initiating an RA procedure on the cell. The UE can obtain an UL transmit timing adjustment (TA) value in a random access reply (RAR).

A second failure case may include failure on TRP1 302A. In failure case, two problems may be possible. If the UE 110 is configured with LRR per TRP1 and TRP2 302B, and a new beam is found in TRP1, the UE may attempt to transmit a SR toward TRP1 (for BFR MAC CE transmission), but with UL transmit timing corresponding to TRP2 (where the UL is currently configured). TRP1 may not be able to receive the transmission if the propagation delay difference between TRP1 and TRP2 is above the length of a guard period (e.g., cyclic prefix-CP) between units of data (symbols) transmitted by the TRPs. A second problem that may be possible is that the UE may not be able to find or recover a new beam on TRP1. In this case, the UE may not be able to transmit a SR and BFR MAC CE to TRP1; and therefore, the network may be without information of beam failure on the TRP1 link until BFR is over.

A third failure case is related to a failure on TRP2 302B. In this case, the UL connection towards TRP2 breaks together with the DL. If another beam is found at TRP2, then recovery can follow existing procedures. However, if the link to TRP2 cannot be used anymore, then the UE 110 may need to make a complete BFR to a new TRP. The UL may be interrupted during beam recovery, whereas the link to TRP1 302A may be expected to stay reliable enough and can be used for UL as well. A further potential problem may be that the UL transmit timing towards TRP1 and TRP2 is very different. If the UE 110 transmits with the same UL transmit Timing Advance (TA) towards TRP1 as for TRP2, when TRP1 actually has different timing, then TRP1 may not receive the transmission.

Given the above failure cases, it can be appreciated that there is currently no means for the UE 110 to indicate the need to switch the UL with TRP2 302B to TRP1 302A or another serving TRP, before beam failure may happen. Furthermore, after the beam failure occurs, it cannot be always ensured that the SR for the following BFR MAC CE transmission can be delivered to a new TRP due to the potential difference in the UL transmit timing. Example implementations of the present disclosure address these and possibly other problems. In some examples, the first issue may be addressed by a means to enable the UE to identify situations where beam failure is likely, and preemptively switch TRPs. The second issue may be addressed in some examples by a means for the UE to autonomously adjust UL transmit timing to ensure that if a beam failure does occur, the correct timing may be employed to enable UL transmission toward the second (non-failed) TRP.

Before describing the potential cures mentioned above more specifically, it may be worthwhile to note that example implementations of the present disclosure are not limited to the specific HST FR2 scenario with simultaneous two-panel reception. However, example implementations may be particularly well suited to addressing situations such as the tunnel scenario mentioned above, where the beam failure can happen due to the sharp drop of the beamformed signal next to the TRP.

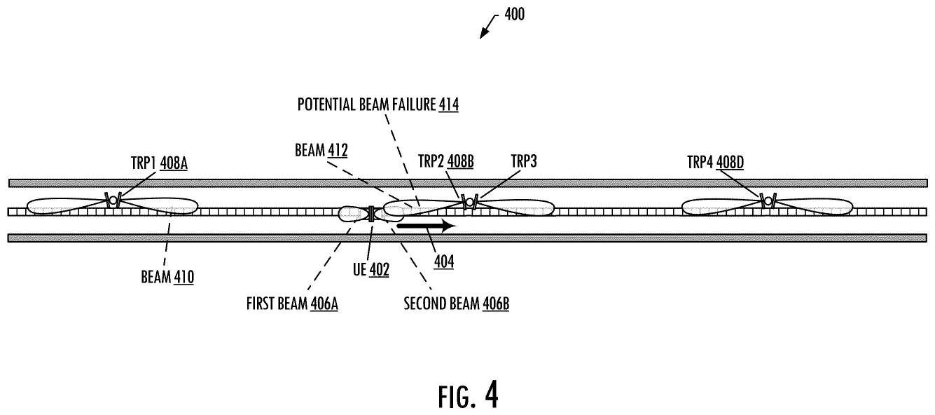

FIG. 4 illustrates a deployment scenario 400 in which the HST FR2 UE 402 is expected to experience beam failure condition described in the third failure case above. The UE has two antenna panels facing opposite directions on an HST moving in the direction shown by arrow 404. The two antenna panels are generating a first beam 406A and a second beam 406B. At the time indicated in FIG. 4, the first beam is directed toward a first TRP 408A (TRP1) and a beam 410 generated by TRP1. Meanwhile, the second beam is directed toward a second TRP 408B (TRP2) and a beam 412 generated by TRP2. Since the UE is much closer to the TRP2 than to TRP1, the signal strength from TRP2 may be higher, and the UE may be expected to use the link to/from TRP2 for both DL and UL. Meanwhile, the UE may pass relatively quickly to a point at which a fourth TRP 408D (TRP 4) would be expected to become the best source for connectivity.

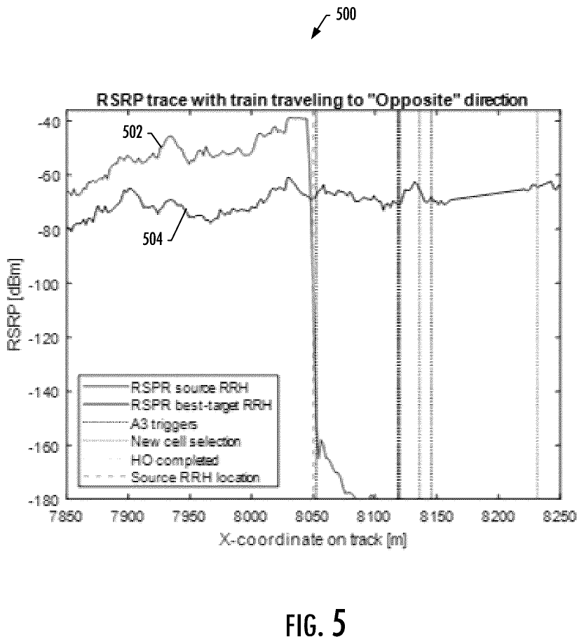

When the HST advances to a point that places the UE 402 at a potential failure point 414, beam coverage from TRP 408B may sharply decrease. FIG. 5 illustrates a plot 500 of reference signal received power (RSRP) versus distance along the HST rail track. Line 502 shows RSRP from TRP2 as the UE approaches the potential failure point of FIG. 4 as being higher than RSRP for TRP4 408D, which is shown by line 504. RSRP for TRP4 of line 504 stays relatively stable and, after the potential failure point is actually much higher than that of line 502. This change is dramatically sharp, and can happen so fast that there may not be enough time for the UE to switch the DL (and also UL) link from TRP2 (source TRP) to TRP4 (best target TRP).

In previous releases associated with multi-TRP scenarios, and scenarios that do not consider high mobility situations, it was assumed by default that there is no significant propagation delay difference between TRP1 408A, TRP2 408B, and TRP4 408D (i.e., that the difference in delay is below the CP length). Example implementations of the present disclosure therefore aim to provide support for situations in which a difference in propagation delay, such as a maximum receive timing difference (MRTD), is greater than the length of the CP or other guard period.

Returning to FIG. 3, some example implementations may provide a method for preventing an UL interruption due to UL failure together with DL failure towards TRP2 302B. To accomplish this, the UE 110 may be provided with a capability to identify degradation of a TRP link where the UL is used more dynamically and, for example, before any actual beam failure takes place. The UE may therefore signal the network regarding the degradation of the TRP link by providing a TRP link degradation indication. In various examples, this indication may be provided by a dedicated signal or extending/adopting another signal, such as a UL SR, measurement report, etc., to include information indicative of the degradation.

In some examples, the UE 110 may be configured (or otherwise include a component configured) to compare link quality on TRP1 302A and TRP2 302B, and providing a timely indication to the network (e.g., radio access node 202 regarding a need to switch UL from TRP2 to TRP1. As noted above, this indication can be provided to the network by modification of existing signals such as a SR or measurement report, or by a dedicated signal, which may be referred to generally as providing UE assistance information (associated with indicating link degradation). Based on the link degradation indication, switching of UL (e.g., of UL spatial relation or UL TCI state) can be accepted faster by the network, and confirmation may be transmitted not through the MAC CE or RRC signaling, but in a DCI message, for example.

This method may be modified slightly in some cases. For example, in some scenarios (e.g., in HST FR2 tunnel), the network (e.g., radio access node 108, CN 106) may have information about potential link failure when certain UE conditions occur based on experience. The information that the network may use for this purpose may include various parameters related to the mobility of the UE 110 such as direction and/or speed of movement, receiver configurations, and/or the like. Hence, the network can avoid using one of the TRP links that is more BF-prone for UL or preclude switching to a link even if it is reported as the better one by the UE based on having a higher RSRP value.

As introduced above, some example implementations may be effective to prevent UL interruption, Some example implementations may also facilitate recovery from a beam failure. In some examples in which the UE 110 is connected to TRP1 302A and TRP2 302B in DL and only one of these links/beams fails, it may be beneficial for the UE 110 to start using the other link as fast as possible also in the UL. Since the non-failed link is already used by the UE in DL and may be stable, there may be no need for the UE to wait for BFR on the failed TRP to be completed during which the UL connection may be interrupted. The use of this reliable enough non-failed link may allow the UE to maintain connection to the serving cell both in UL and DL. This may also provide the UE and the network with more time to perform measurements and to find a good new beam for the same or another TRP to start serving the UE from multiple TRPs again.

By the above, some example implementations may be effective to respond to a beam failure, and may be accomplished by providing the UE 110 with a new capability for autonomously adjusting UL transmit timing in the case of beam failure to enable UL transmission towards TRP1 302A. The UE may also to decide between various options after the beam failure. The options may include checking for a need for and performance of an autonomous UL timing adjustment to send SR and following BFR MAC CE over the non-failed link/beam, switching to the other link by sending an RA preamble, or initiating link recovery to a new TRP. This may be the case, for example, when no new candidate beam from TRP2 302B is available and switching UL to TRP1 302A is also not preferred. In this context, the UE may also indicate an UL switch from TRP2 to TRP1 with BFR MAC CE (or a new MAC CE) even before the new recovery beam for TRP2 or another TRP is identified. In one option, the UE may indicate a need for UL beam switch from TRP2 to TRP1 in the case of beam failure by sending SR over LRR, i.e., without the following BFR MAC CE.

Some example implementations may also address failure on the link that is not used for UL, i.e., on TRP1 302A. Following conventional practices, if LRR is configured, the UE 110 should send UL SR towards TRP1 to indicate a new beam. This operation may not succeed, however, if the UL transmit timing difference towards TRP1 is very different (e.g., above CP) than that for TRP2 302B, where the UL is currently configured. As a solution, instead of sending UL SR and BFR MAC towards TRP1, the UE may be provided with a capability indicate BF on one TRP over the UL to the other TRP. The UE may also evaluate a degree to which the propagation delay is different between TRP1 and TRP2. If UL transmit timing between TRP1 and TRP2 is very different (e.g., above a threshold difference value), the UE may inform the network and receive a new candidate beam on TRP1 through PUCCH on TRP2. The network either switches the DL beam on TRP1 towards the beam indicated by the UE in BFR MAC CE or just confirms the beam switch (e.g., via DCI from TRP2).

Some example implementations of the present disclosure may therefore provide a UE 110 connected to both TRP1 302A and TRP2 302B. The UE has a first DL connection and a second DL connection with respectively TRP1 and, but an UL connection with only TRP2. The UE 110 may signal the network (via TRP2) of UE capabilities including a capability of switching between TRPs, and RRC control signaling from the network to enable the capability at the UE.

The UE 110 may be configured to monitor a radio link quality of the second DL connection with TRP2 302B, and identify a condition for switching the UL connection, based on at least the radio link quality of the second DL connection. In some examples, the condition may be degradation of the second DL connection, which may be identifed by comparison with the first DL connection. In this regard, the UE may monitor a first radio link quality of TRP1 302A, and a second radio link quality of TRP2, and identify degradation of the second DL connection based on (a comparison of) the first radio link quality and the second radio link quality. In some examples, the condition may be for switching either or both of a UL control channel (PUCCH) or a UL shared channel (PUSCH) of the UL connection.

The UE 110 may be configured to switch the UL connection from TRP2 302B to TRP1 302A, based on the determination. In particular, for example, the UE may signal the network (TRP2 302B) to request switching the UL connection to TRP1.

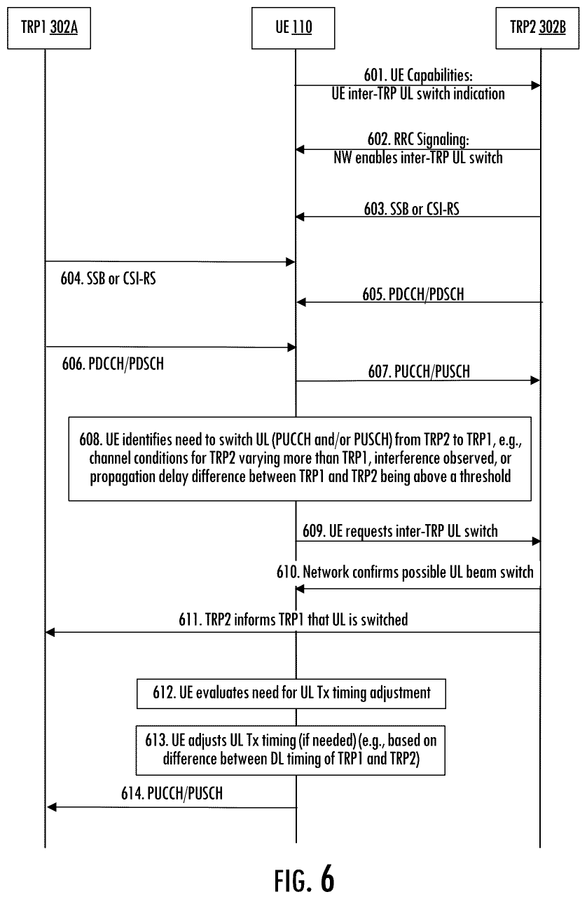

FIG. 6 is a signaling chart 600 for preventing UL interruption, according to some example implementations. In this regard, FIG. 6 shows a scenario when UE 110 indicates a need to switch from TRP2 302B to TRP1 302A. In this example, the UE may possess additional, more dynamic and up-to-date information about the status of the links towards TRP1 and TRP2 than the network. Even if the beam failure happens on TRP2 later on, the UL connectivity from the UE may not be interrupted. Moreover, the switching UL between two links already used for DL can be arranged with less delay and less signaling overhead. For example, more dynamic DCI signaling can be used just to acknowledge the UL change from TRP2 to TRP1.

Referring to FIG. 6, steps 601-614 are shown and described. Notably, step 601 includes an example of an existing message from the UE 110 to the TRP2 302B to indicate UE capabilities. However, the existing message is further modified by an example implementation to include a switch indication (e.g., a UL inter-TRP switch indication) as described above. Step 602 further adds to existing RRC signaling messaging an indication from the network (via TRP2) to enable the UL inter-TRP switch, if needed. Steps 603, 604, 605, 606 and 607 describe UE measurements based on SSB/CSI-RS transmitted from the TRPs, and data exchange over PDSCH/PUSCH, and control information exchange over PUCCH/PDCCH, and may be as currently specified by various 3GPP standards. At step 608, the UE identifies the need to switch UL from TRP2 to TRP1 302A. The request for switching at step 609 may be use dedicated signaling or modifications to existing signaling (e.g., SR, measurement report). The indication by the network at step 610 regarding UL switching may also be implemented with existing signaling (e.g., spatial relation switch MAC CE) or with new signaling (e.g., DCI acknowledgement for inter-TCI UL switch). Steps 611, 612, 613 and 614 may continue the process of switching UL to TRP1 from TRP2.

Some other example implementations introduced above provide a network node, such as a radio access node 202, or other network node or RAN 108 or CN 106. In some of these other example implementations, the network node may be configured to collect operational information including information relating to one or more of TRP1 302A, TRP2 302B, or UE 110. The operational information may additionally or alternatively include, for example, information relatating to other neighboring TRPs or cells. The network node may be configured to perform an evaluation of the operational information for potential UL failure at either of TRP1 or TRP2, and make a determination whether or not to switch the UL connection from TRP2 to TRP1, based on the evaluation. As suggested above, in some examples, the operational information includes beam failure information of at least one of TRP1 302A or TRP2 302B. The operational information may also include one or more of signal strength of at least one of TRP1 or TRP2, location of the UE 110, speed of the UE, direction of travel of the UE, or interference in an environment of at least one of TRP1, TRP2 or the UE.

In some examples, when the evaluation indicates the potential UL failure at TRP1 302A, the network node may make the determination to not switch the UL connection. In some other examples, when the evaluation indicates the potential UL failure at TRP2 302B, the network node may make the determination to switch the UL connection. In some of these examples, the network node 202 is further configured to switch the UL connection from TRP2 to TRP1, based on the determination.

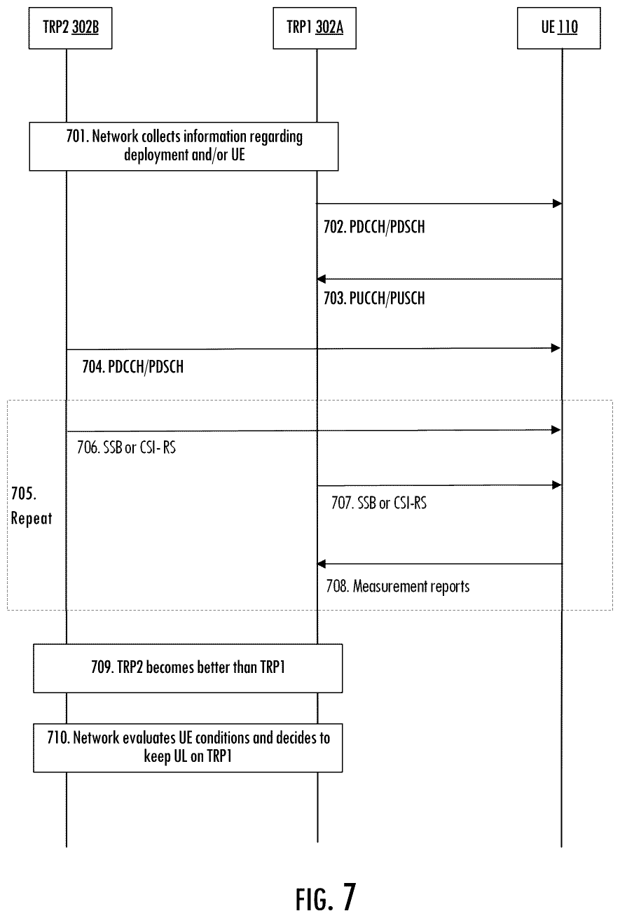

To further illustrate some of the above example implementations, FIG. 7 is a signaling chart for preventing UL interruption, using experience-based information from the network side to anticipate a potential need for UL switching, according to some example implementations. Relative to FIG. 6, the signaling in FIG. 7 is more focused on the network side. In step 701, the network collects additional information that enables decision making regarding a need for UL switch between TRP1 302A and TRP2 302B. In one example, the network may collect the statistics of BFs in an area combined with other additional information e.g., signal strengths of TRPs, UE location, speed, interference, etc.

Steps 702, 703 and 704 represent typical signaling where DL connection of the UE 110 is to both TRP1 302A and TRP2 302B, but UL connection is only to TRP1. A repeated execution of routine signaling between TRP1 and TRP2 is shown at 705, including steps 706 and 707, and with measurement reports being provided by the UE to the network via TRP1 at step 708. If at step 709, TRP2 appears to provide better connectivity potential than TRP1, then at step 710, based on collected data, the network may predict a possibility of BF. In response, even if the quality of the link to TRP2 becomes better than that of TRP1, if the network has a higher probability of BF in TRP2 than in TRP1, the network may direct keeping the UL at TRP1.

In some examples, such as the HST FR2 tunnel deployment from FIG. 4, the network may collect information about the movement direction of the UE, e.g., what were the previous TRPs of the UE or what is the sign of frequency offset at step 701. This experience-based information may enable the network to conclude in step 710, whether the UE is travelling towards TRP1 302A or TRP2 302B. In this example, if TRP2 is determined to be more BF-prone, the network may decide to keep the UL at TRP1 even though the signal strength from TRP2 was found to be better at step 709. In step 710, the network may also take additional information regarding the UE and/or network configuration. For example, if discontinuous reception (DRX) is enabled and TRPs are located in the tunnel, then TRP2 may be avoided for the UL.

Briefly returning to FIG. 3, in yet other example implementations, the UE 110 may be configured to detect a beam failure of the second DL connection with TRP2 302B. The UE may perform an evaluation of a UL condition of TRP1, and make a determination to switch the UL connection from TRP2 to TRP1 302A or a third TRP, based on the evaluation. The UE may then be configured to switch the UL connection from TRP2 to TRP1 or the third TRP, based on the determination, such as by signaling the network to request switching the UL.

In some examples in which the determination is made to switch the UL connection from TRP2 302B to TRP1 302A, the UE 110 may make a second determination whether or not the UE is able to determine a timing adjustment of TRP1 302A, and switch the UL connection from TRP2 to TRP1 based on the second determination. If the second determination is that the UE is able to determine the timing adjustment, the UE may determine the timing adjustment; and using the timing adjustment, the UE may signal the network via TRP1 to request switching the UL connection to TRP1. If the second determination is that the UE is unable to determine the timing adjustment, the UE may signal the network via a random access channel of TRP1 to obtain the timing adjustment; and using the timing adjustment, the UE may signal the network to request switching the UL connection to TRP1.

In some examples in which the determination is made to switch the UL connection from TRP2 302B to the third TRP, the UE 110 may signal the network via a preamble transmission to the third TRP to obtain a timing adjustment of the third TRP. And using the timing adjustment, the UE may signal the network via the third TRP to request switching the UL connection to the third TRP.

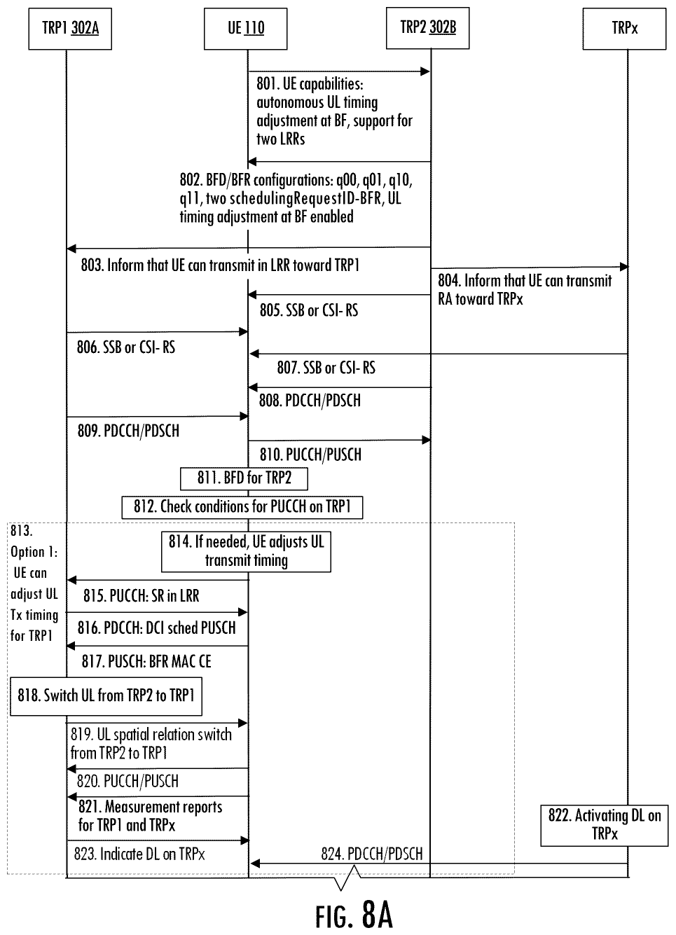

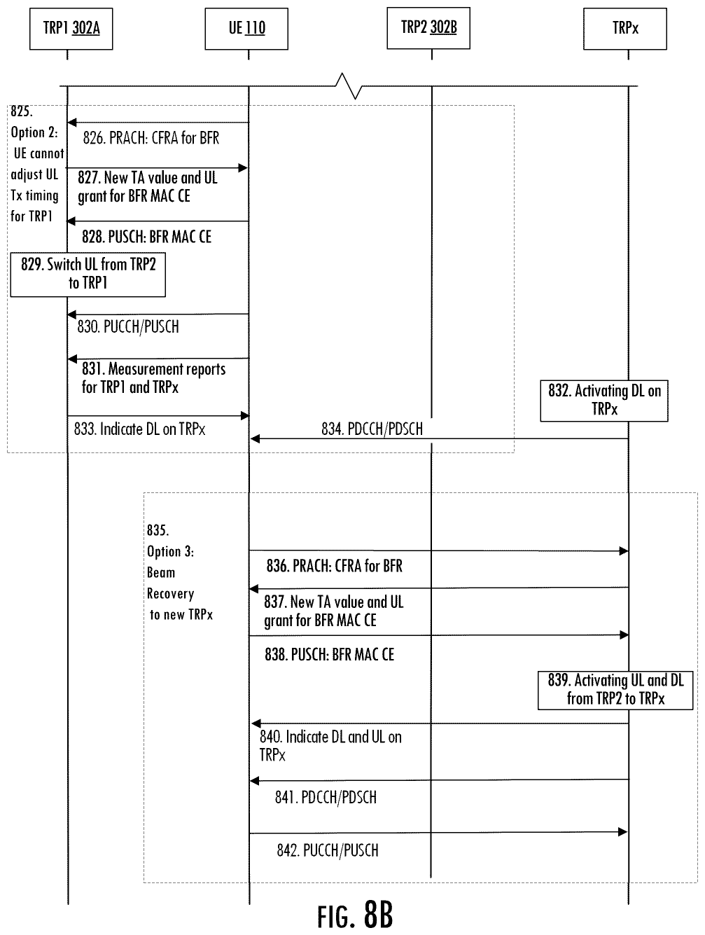

FIGS. 8A and 8B is a signaling chart for responding to a beam failure by autonomously adjusting UL transmit timing, according to some example implementations. A shown at steps 801, 802, 803 and 804, the UE 110 may signal the network, via TRP2 302B, of UE capabilities including a capability to autonomously adjust UL timing TRP1 302A and TRP2, in the event of BF, and the network may enable the capability. The network may also signal BFD/BFR configurations to the UE, such as periodic reference signal resources (q̅_{0,0} and q̅_{0,1}), two configurations for PUCCH transmission with a LRR for TRP1 and TRP2 (schedulingRequestID-BFR), etc.

Steps 805-810 describe sending reference signals and sending UL and DL data/control information, similar to steps 603-607, and may be as currently specified by various 3GPP standards.

The UE at step 811 may detect a beam failure on the UL connection with TRP2 302B; and at step 812, the UE may evaluate a UL condition of TRP1, such as conditions for PUCCH on TRP1, and make a determination to switch the UL connection from TRP2 to TRP1 302A or a third TRP (TRPx), based on the evaluation.

As a first option at 813, the UE 110 determines that the UE is able to transmit in UL towards TRP1 302A. This may be possible, for example, if the propagation delay difference between TRP1 and TRP2 302B is less than a threshold difference (e.g., less than the length of CP), or if the UE can reliably evaluate the timing difference between TRP1 302A and TRP2 302B. At step 814, UE evaluates if the UL transmit timing adjustment is needed, and performs the UL transmit timing adjustment if needed.

At steps 815, 816 and 817, UE sends a UL SR and BFR MAC CE to the network via TRP1, and receives a DCI to schedule a PUSCH. By this signaling, the UE may inform the network about beam failure on TRP2, and request switching the UL to TRP1. The signaling towards TRP1 means that the UL should be switched from TRP2 to TRP1 even if UE may not indicate a new beam for recovery yet (in BFR MAC CE, AC field can be 0). Note that by default, UE may not be expected to use the TRP1 beam for recovery because DL beam for TRP1 has not failed. The network via TRP2 then switches the UL from TRP2 to TRP1 at step 818.

As also shown, steps 819-824 may be as currently specified by various 3GPP standards.

As a second option at 813, shown in FIG. 8B, the UE 110 determines that the UE is unable to transmit in UL towards TRP1 302A. That is, the UE concludes that the UE is unable to perform a one-shot/autonomous timing adjustment for transmit to TRP1, which may be because DL synchronization to TRP2 is already lost or outdated. In this case, even though LLR resources are configured, the network may not expect an SR via TRP1. The UE may therefore at step 826 initiate a RA preamble transmission towards TRP1, and at step 827 receive a new timing adjustment value and UL grant for BFR MAC CE. The UE may then at step 828 send a BFR MAC CE to the network (via TRP1), which the network may interpret as a need to switch UL to TRP1 and not as a final BFR. The network via TRP2 then switches the UL from TRP2 to TRP1 at step 829.

As also shown, at steps 830-834, the DL from TRP1 may be switched to the third TRPx.

In a third option, at 835 and over steps 836-842, the UE may decide to recover, and then recover, from beam failure directly to the third TRPx. This may be the case, for example, if no candidate beams were detected for TRP2 302B and enabling UL on TRP1 302A has a similar overhead (e.g., autonomous UL timing adjustment cannot be performed and RACH is also needed).

Again returning to FIG. 3, in yet again other example implementations, the UE 110 may be configured to detect a beam failure of the first DL connection with TRP1 302A. In some of these examples, UE is configured to evaluate a difference in propagation delay between TRP1 and TRP2. The UE may make a determination whether to perform a beam recovery procedure to recover the first DL connection, with TRP1 or through the UL connection with TRP2, based on the difference in propagation delay. The UE may then perform the beam recovery procedure based on the determination.

In particular, for example, the UE may make the determination based on the difference in propagation delay and a threshold difference, such as a length of a guard period (e.g., CP) between units of data transmitted by TRP1 302A and TRP2 302B. If the difference in propagation delay is less than (or no greater than) a threshold difference, the UE may determine to perform the beam recovery procedure with TRP1 302A. This beam recovery procedure may be as or similar to that specified in 3GPP specifications.

If the difference in propagation delay is greater than a threshold difference, the may instead perform the beam recovery procedure through the UL connection with TRP2 302B. In this regard, the UE 110 may signal the network (via the UL connection with TRP2) to indicate a candidate DL beam of TRP1 302A for recovery of the first DL connection. The UE may then receive a message from the network to instruct the UE to switch to the candidate DL beam, or acknowledge a switch to the candidate DL beam.

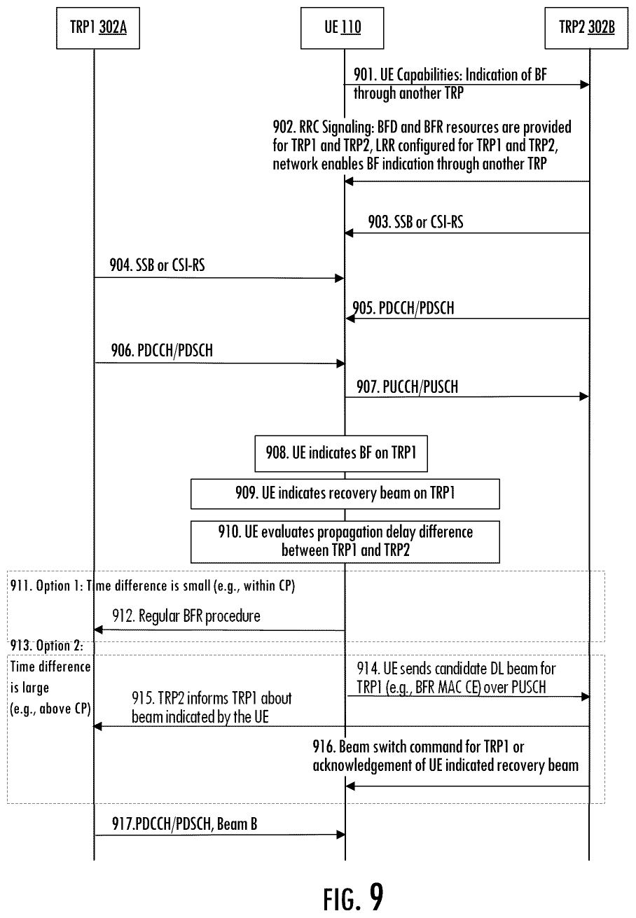

FIG. 9 is a signaling chart for recovering the first DL connection with TRP1 302A, using the UL connection with TRP2 302B, according to some example implementations. A shown at steps 901 and 902, the UE 110 may signal the network, via TRP2 302B, of UE capabilities including an indication of BF through another TRP, and the network may provide RRC signaling to enable the capability. The network may also signal BFD and BFR resources for TRP1 and TRP2, and that LLR is configured for both TRP1 and TRP2.

Steps 903-907 describe sending reference signals and sending UL and DL data/control information, and may be as currently specified by various 3GPP standards.

The UE 110 at steps 908 and 909 indicates BF on TRP1 302A, and a recovery beam on TRP1. At step 910, the UE evaluates the propagation delay difference between TRP1 and TRP2 302B. As a first option, at 911, the UE determines the time difference is within CP, and the UE performs a regular BFR procedure with TRP1, at step 912. This beam recovery procedure may be as or similar to that specified in 3GPP specifications.

As a second option, at 913, the UE determines the time difference is larger than CP, and the UE performs a BFR procedure using the UL connection with TRP2 302B. The UE at step 914 sends a candidate beam for TRP1 to the network via the UL connection with TRP2, such as in a BFR MAC CE over PUSH. TRP2 at step 915 informs TRP1 about the beam indicated by the UE. At step 916, the network via TRP2 sends a beam switch command for TRI or an acknowledgement of the UE indicated recovery beam. In this regard a beam switch command, such as a TCI state switch command, may indicate specifically that the beam is switched for TRP1 302A even though the command is coming from TRP2. Alternatively, the network may send an acknowledgment of a switch to the beam (indicated by the UE in BFR MAC CE at TRP1), such as in new DCI message.

FIGS. 10A and 10B are flowcharts illustrating various steps in a method 1000, according to various example implementations. The method includes monitoring a radio link quality at a user equipment connected to both a first transmission-reception point (TRP) and a second TRP of a network, as shown at block 1002 of FIG. 10A, The user equipment has a first downlink (DL) connection and a second DL connection with respectively the first TRP and the second TRP, but an uplink (UL) connection with the second TRP but not the first TRP; and the radio link quality monitored is of the second DL connection with the second TRP. The method includes identifying a condition for switching the UL connection, based on at least the radio link quality of the second DL connection, as shown at block 1004. And the method includes switching the UL connection from the second TRP to the first TRP, based on the determination, as shown at block 1006.

In some examples, the method 1000 further includes signaling the network, from the user equipment via the second TRP, of user equipment capabilities including a capability of switching between TRPs, as shown at block 1008 of FIG. 10B. In some of these examples, the method also includes receiving radio resource control signaling at the user equipment, from the network via the second TRP, to enable the capability at the user equipment, as shown at block 1010.

In some examples, monitoring the radio link quality at block 1002 includes monitoring a first radio link quality of the first TRP, and a second radio link quality of the second TRP. In some of these examples, the condition is a degradation in the second DL connection, and the condition is identified at block 1004 based on the first radio link quality and the second radio link quality.

In some examples, the condition that is identified at block 1004 is a condition for switching at least one of a UL control channel or a UL shared channel of the UL connection. In some of these examples, switching the UL connection at block 1006 includes switching the at least one of the UL control channel or the UL shared channel.

In some examples, switching the UL connection at block 1006 includes signaling the network, from the user equipment via the second TRP, to request switching the UL connection to the first TRP.

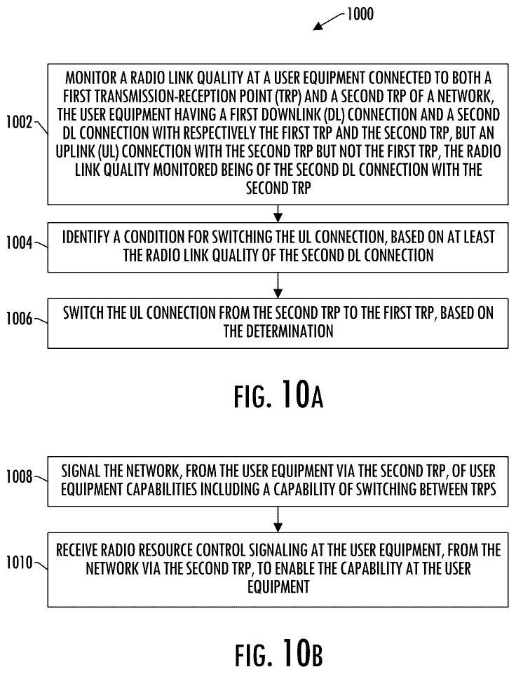

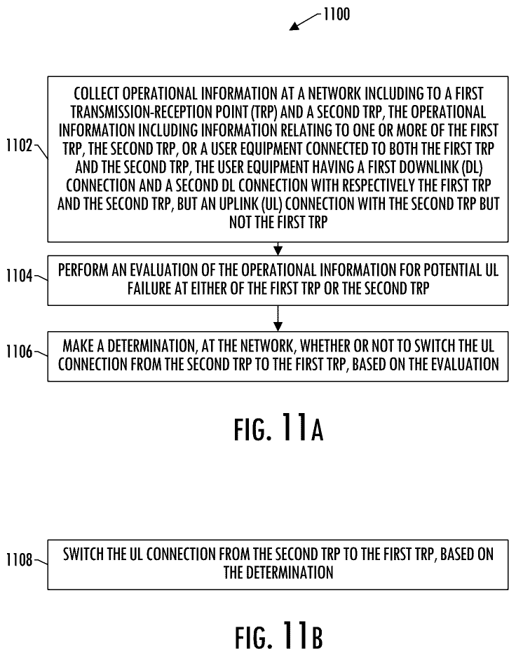

FIGS. 11A and 11B are flowcharts illustrating various steps in a method 1100, according to various example implementations. The method includes collecting operational information at a network including to a first transmission-reception point (TRP) and a second TRP, as shown at block 1102 of FIG. 11A. The operational information relates to one or more of the first TRP, the second TRP, or a user equipment connected to both the first TRP and the second TRP. The user equipment has a first downlink (DL) connection and a second DL connection with respectively the first TRP and the second TRP, but an uplink (UL) connection with with the second TRP but not the first TRP. The method includes performing an evaluation of the operational information for potential UL failure at either of the first TRP or the second TRP, as shown at block 1104. And the method includes making a determination, at the network, whether or not to switch the UL connection from the second TRP to the first TRP, based on the evaluation, as shown at block 1106.

In some examples, the operational information includes beam failure information of at least one of the first TRP or the second TRP

In some examples, the operational information also includes one or more of signal strength of at least one of the first TRP or the second TRP, location of the user equipment, speed of the user equipment, direction of travel of the user equipment, or interference in an environment of at least one of the first TRP, the second TRP or the user equipment.

In some examples, when the evaluation indicates the potential UL failure at the first TRP, the determination is made at block 1106 to not switch the UL connection.

In some examples, when the evaluation indicates the potential UL failure at the second TRP, the determination is made at block 1106 to switch the UL connection. In some of these examples, the method 1100 further includes switching the UL connection from the second TRP to the first TRP, based on the determination, as shown at block 1108 of FIG. 11B.

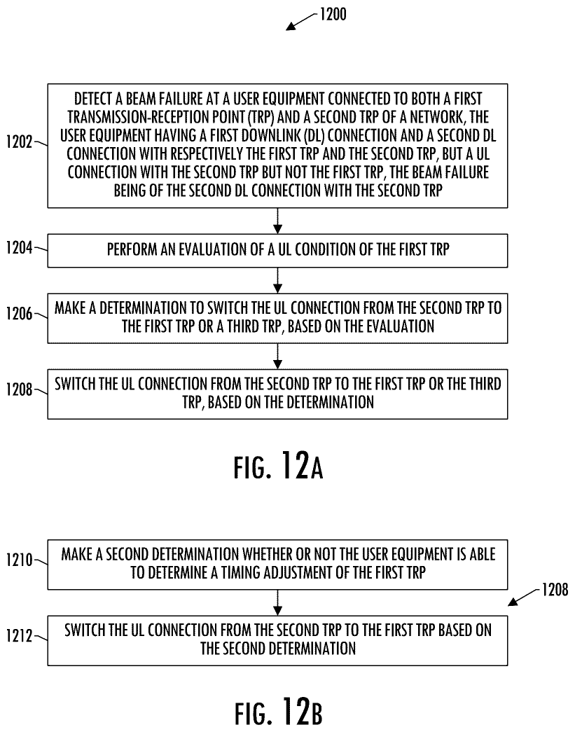

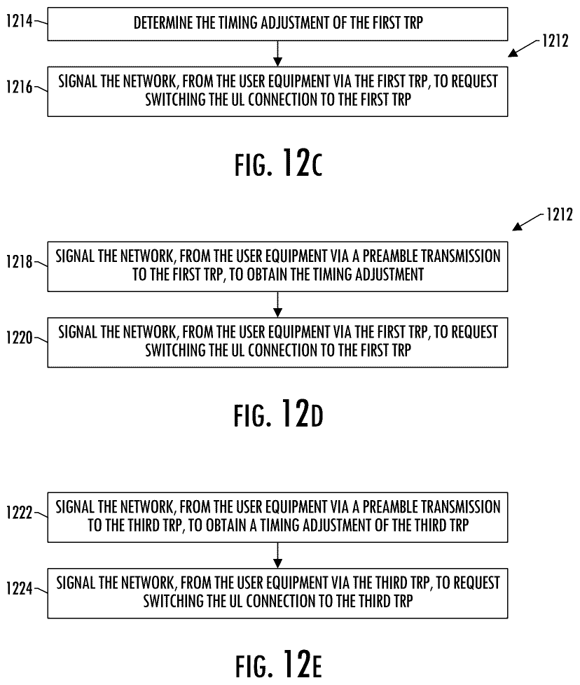

FIGS. 12A-12E are flowcharts illustrating various steps in a method 1200, according to various example implementations. The method includes detecting a beam failure at a user equipment connected to both a first transmission-reception point (TRP) and a second TRP of a network, as shown at block 1202 of FIG. 12A. The user equipment has a first downlink (DL) connection and a second DL connection with respectively the first TRP and the second TRP, but a UL connection with with the second TRP but not the first TRP; and the beam failure is of the second DL connection with the second TRP. The method includes performing an evaluation of a UL condition of the first TRP, as shown at block 1204. The method includes making a determination to switch the UL connection from the second TRP to the first TRP or a third TRP, based on the evaluation, as shown at block 1206. And the method includes switching the UL connection from the second TRP to the first TRP or the third TRP, based on the determination, as shown at block 1208.

In some examples, when the determination is made at block 1206 to switch the UL connection from the second TRP to the first TRP, the method further includes making a second determination whether or not the user equipment is able to determine a timing adjustment of the first TRP, as shown at block 1210 of FIG. 12B. In some of these examples, switching the UL connection at block 1208 includes switching the UL connection from the second TRP to the first TRP based on the second determination, as shown at at block 1212.

In some examples, when the second determination is made at block 1210 that the user equipment is able to determine the timing adjustment of the first TRP, the method further includes determining the timing adjustment of the first TRP, as shown at block 1214 of FIG. 12C. And using the timing adjustment, switching the UL connection from the second TRP to the first TRP at block 1212 includes signaling the network, from the user equipment via the first TRP, to request switching the UL connection to the first TRP, as shown at block 1216.

In some examples, when the second determination is made at block 1210 that the user equipment is unable to determine the timing adjustment, switching the UL connection from the second TRP to the first TRP at block 1212 includes signaling the network, from the user equipment via a preamble transmission to the first TRP, to obtain the timing adjustment, as shown at block 1218 of FIG. 12D. And using the timing adjustment, the method includes signaling the network, from the user equipment via the first TRP, to request switching the UL connection to the first TRP, as shown at block 1220.

In some examples, when the determination is made at block 1206 to switch the UL connection from the second TRP to the third TRP, the method further includes signaling the network, from the user equipment via a preamble transmission to the third TRP, to obtain a timing adjustment of the third TRP, as shown at block 1222 of FIG. 12E. And using the timing adjustment, the method includes signaling the network, from the user equipment via the third TRP, to request switching the UL connection to the third TRP, as shown at block 1224.

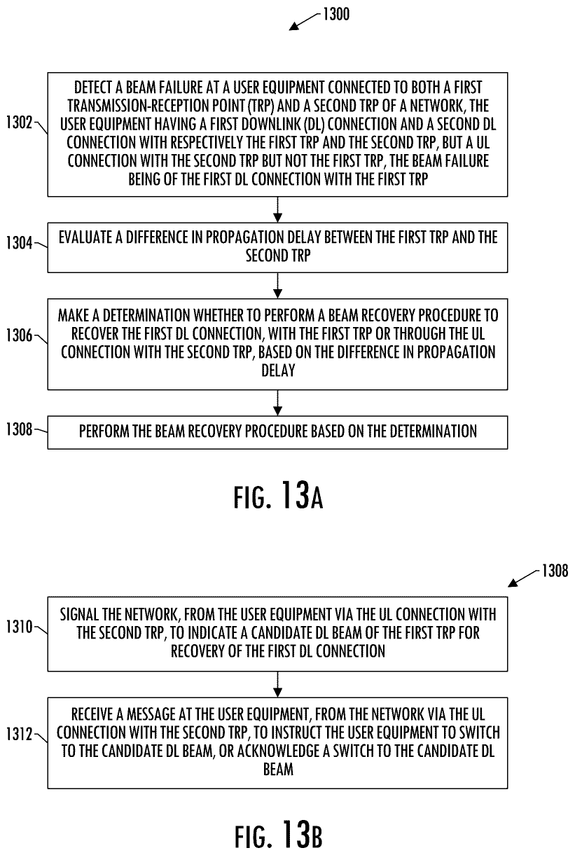

FIGS. 13A and 13B are flowcharts illustrating various steps in a method 1300, according to various example implementations. The method includes detecting a beam failure at a user equipment connected to both a first transmission-reception point (TRP) and a second TRP of a network, as shown at block 1110 of FIG. 13A. The user equipment has a first downlink (DL) connection and a second DL connection with respectively the first TRP and the second TRP, but a UL connection with with the second TRP but not the first TRP; and the beam failure is of the first DL connection with the first TRP. The method includes evaluating a difference in propagation delay between the first TRP and the second TRP, as shown at block 1302. The method includes making a determination whether to perform a beam recovery procedure to recover the first DL connection, with the first TRP or through the UL connection with the second TRP, based on the difference in propagation delay, as shown at block 1306. And the method includes performing the beam recovery procedure based on the determination, as shown at block 1308.

In some examples, the determination is made at block 1306 based on the difference in propagation delay and a threshold difference, and the threshold difference is a length of a guard period between units of data transmitted by the first TRP and the second TRP.

In some examples, when the difference in propagation delay is less than a threshold difference, the determination is made at block 1306 to perform the beam recovery procedure with the first TRP.

In some examples, when the difference in propagation delay is greater than a threshold difference, the determination is made at block 1306 to perform the beam recovery procedure through the UL connection with the second TRP.

In some examples further, performing the beam recovery procedure through the UL connection with the second TRP at block 1308 includes signaling the network, from the user equipment via the UL connection with the second TRP, to indicate a candidate DL beam of the first TRP for recovery of the first DL connection, as shown at block 1310 of FIG. 13B. And in some of these examples, the method includes receiving a message at the user equipment, from the network via the UL connection with the second TRP, to instruct the user equipment to switch to the candidate DL beam, or acknowledge a switch to the candidate DL beam, as shown at block 1312.

According to example implementations of the present disclosure, a telecommunications system 100 or PLMN 102, and its components such as CN 106, RAN 108, UE 110, 402, radio access node 202, first TRP 302A and/or second TRP 302B, may be implemented by various means. Means for implementing the system and its components may include hardware, alone or under direction of one or more computer programs from a computer-readable storage medium, such as computer memory (or more simply “memory”). In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

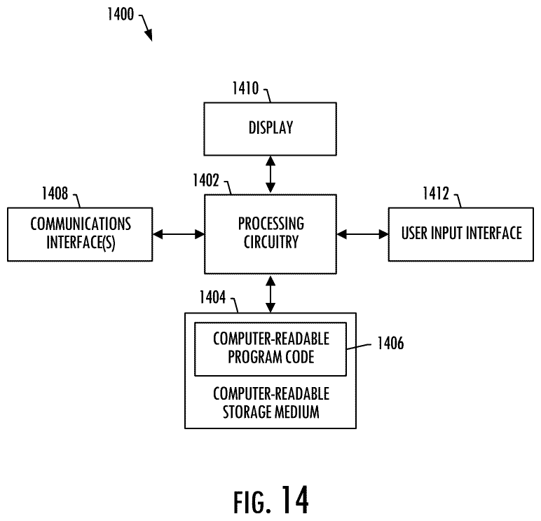

FIG. 14 illustrates an apparatus 1400 according to some example implementations of the present disclosure. Generally, an apparatus of exemplary implementations of the present disclosure may comprise, include or be embodied in one or more fixed or portable electronic devices. Examples of suitable electronic devices include a wearable computer, mobile phone, portable computer, desktop computer, workstation computer, server (server computer) or the like. The apparatus may include one or more of each of a number of components such as, for example, processing circuitry 1402 connected to computer-readable storage medium 1404.

The processing circuitry 1402 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the computer-readable storage medium 1404 (of the same or another apparatus).

The processing circuitry 1402 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The computer-readable storage medium 1404 is generally any piece of computer hardware that is capable of storing information such as, for example, data, computer programs (e.g., computer-readable program code 1406) and/or other suitable information either on a temporary basis and/or a permanent basis. The computer-readable storage medium may include volatile and/or non-volatile memory, and may be fixed or removable. Examples of suitable memory include random access memory (RAM), read-only memory (ROM), a hard drive, a flash memory, a thumb drive, a removable computer diskette, an optical disk or some combination of the above. The computer-readable storage medium is a non-transitory device capable of storing information, and is distinguishable from computer-readable transmission media such as electronic transitory signals capable of carrying information from one location to another. The term “non-transitory,” as used herein, is a limitation of the medium itself (i.e., tangible, not a signal) as opposed to a limitation on data storage persistency (e.g., RAM versus ROM). Computer-readable medium as described herein may generally refer to a computer-readable storage medium or computer-readable transmission medium.

In addition to the computer-readable storage medium 1404, the processing circuitry 1402 may also be connected to one or more interfaces for displaying, transmitting and/or receiving information. The interfaces may include a communications interface 1408 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 1410 and/or one or more user input interfaces 1412. The display may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in a computer-readable storage medium, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 1400 may include a processing circuitry 1402 and a computer-readable storage medium 1404 coupled to the processing circuitry, where the processing circuitry is configured to execute computer-readable program code 1406 stored in the computer-readable storage medium. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations, as well as those thereafter presented in the appended claims.

Clause 1. An apparatus comprising: at least one memory configured to store computer-readable program code; and at least one processing circuitry configured to access the at least one memory, and execute the computer-readable program code to cause the apparatus to at least: monitor a radio link quality at a user equipment connected to both a first transmission-reception point (TRP) and a second TRP of a network, the user equipment having a first downlink (DL) connection and a second DL connection with respectively the first TRP and the second TRP, but an uplink (UL) connection with with the second TRP but not the first TRP, the radio link quality monitored being of the second DL connection with the second TRP; identify a condition for switching the UL connection, based on at least the radio link quality of the second DL connection; and switch the UL connection from the second TRP to the first TRP, based on the determination.

Clause 2. The apparatus of clause 1, wherein the at least one processing circuitry is configured to execute the computer-readable program code to cause the apparatus to further at least: signal the network, from the user equipment via the second TRP, of user equipment capabilities including a capability of switching between TRPs; and receive radio resource control signaling at the user equipment, from the network via the second TRP, to enable the capability at the user equipment.

Clause 3. The apparatus of clause 1 or clause 2, wherein the apparatus caused to monitor the radio link quality includes the apparatus caused to monitor a first radio link quality of the first TRP, and a second radio link quality of the second TRP, and wherein the condition is a degradation in the second DL connection, and the condition is identified based on the first radio link quality and the second radio link quality.

Clause 4. The apparatus of any of clauses 1 to 3, wherein the condition that is identified is a condition for switching at least one of a UL control channel or a UL shared channel of the UL connection, and the apparatus caused to switch the UL connection includes the apparatus caused to switch the at least one of the UL control channel or the UL shared channel.

Clause 5. The apparatus of any of clauses 1 to 4, wherein the apparatus caused to switch the UL connection includes the apparatus caused to signal the network, from the user equipment via the second TRP, to request switching the UL connection to the first TRP.

Clause 6. An apparatus comprising: means for monitoring a radio link quality at an user equipment connected to both a first transmission-reception point (TRP) and a second TRP of a network, the user equipment having a first downlink (DL) connection and a second DL connection with respectively the first TRP and the second TRP, but an uplink (UL) connection with with the second TRP but not the first TRP, the radio link quality monitored being of the second DL connection with the second TRP; means for identifying a condition for switching the UL connection, based on at least the radio link quality of the second DL connection; and means for switching the UL connection from the second TRP to the first TRP, based on the determination.

Clause 7. The apparatus of clause 6, wherein the apparatus further comprises: means for signaling the network, from the user equipment via the second TRP, of user equipment capabilities including a capability of switching between TRPs; and means for receiving radio resource control signaling at the user equipment, from the network via the second TRP, to enable the capability at the user equipment.

Clause 8. The apparatus of clause 6 or clause 7, wherein the means for monitoring includes monitoring a first radio link quality of the first TRP, and a second radio link quality of the second TRP, and wherein the condition is a degradation in the second DL connection, and the condition is identified based on the first radio link quality and the second radio link quality.

Clause 9. The apparatus of any of clauses 6 to 8, wherein the condition that is identified is a condition for switching at least one of a UL control channel or a UL shared channel of the UL connection, and the means for switching includes switching the at least one of the UL control channel or the UL shared channel.

Clause 10. The apparatus of any of clauses 6 to 9, wherein the means for switching includes signaling the network, from the user equipment via the second TRP, to request switching the UL connection to the first TRP.

Clause 11. A method comprising: monitoring a radio link quality at a user equipment connected to both a first transmission-reception point (TRP) and a second TRP of a network, the user equipment having a first downlink (DL) connection and a second DL connection with respectively the first TRP and the second TRP, but an uplink (UL) connection with with the second TRP but not the first TRP, the radio link quality monitored being of the second DL connection with the second TRP; identifying a condition for switching the UL connection, based on at least the radio link quality of the second DL connection; and switching the UL connection from the second TRP to the first TRP, based on the determination.

Clause 12. The method of clause 11, wherein the method further comprises: signaling the network, from the user equipment via the second TRP, of user equipment capabilities including a capability of switching between TRPs; and receiving radio resource control signaling at the user equipment, from the network via the second TRP, to enable the capability at the user equipment.

Clause 13. The method of clause 11 or clause 12, wherein monitoring the radio link quality includes monitoring a first radio link quality of the first TRP, and a second radio link quality of the second TRP, and wherein the condition is a degradation in the second DL connection, and the condition is identified based on the first radio link quality and the second radio link quality.

Clause 14. The method of any of clauses 11 to 13, wherein the condition that is identified is a condition for switching at least one of a UL control channel or a UL shared channel of the UL connection, and switching the UL connection includes switching the at least one of the UL control channel or the UL shared channel.

Clause 15. The method of any of clauses 11 to 14, wherein switching the UL connection includes signaling the network, from the user equipment via the second TRP, to request switching the UL connection to the first TRP.

Clause 16. A computer-readable storage medium that is non-transitory and has computer-readable program code stored therein that, in response to execution by at least one processing circuitry, causes an apparatus to at least: monitor a radio link quality at a user equipment connected to both a first transmission-reception point (TRP) and a second TRP of a network, the user equipment having a first downlink (DL) connection and a second DL connection with respectively the first TRP and the second TRP, but an uplink (UL) connection with with the second TRP but not the first TRP, the radio link quality monitored being of the second DL connection with the second TRP; identify a condition for switching the UL connection, based on at least the radio link quality of the second DL connection; and switch the UL connection from the second TRP to the first TRP, based on the determination.

Clause 17. The computer-readable storage medium of clause 16, wherein the computer-readable storage medium has further computer-readable program code stored therein that, in response to execution by the at least one processing circuitry, causes the apparatus to further at least: signal the network, from the user equipment via the second TRP, of user equipment capabilities including a capability of switching between TRPs; and receive radio resource control signaling at the user equipment, from the network via the second TRP, to enable the capability at the user equipment.

Clause 18. The computer-readable storage medium of clause 16 or clause 17, wherein the apparatus caused to monitor the radio link quality includes the apparatus caused to monitor a first radio link quality of the first TRP, and a second radio link quality of the second TRP, and wherein the condition is a degradation in the second DL connection, and the condition is identified based on the first radio link quality and the second radio link quality.

Clause 19. The computer-readable storage medium of any of clauses 16 to 18, wherein the condition that is identified is a condition for switching at least one of a UL control channel or a UL shared channel of the UL connection, and the apparatus caused to switch the UL connection includes the apparatus caused to switch the at least one of the UL control channel or the UL shared channel.

Clause 20. The computer-readable storage medium of any of clauses 16 to 19, wherein the apparatus caused to switch the UL connection includes the apparatus caused to signal the network, from the user equipment via the second TRP, to request switching the UL connection to the first TRP.

Clause 21. An apparatus comprising means for performing the method of any of clauses 11 to 15.

Clause 22. A computer-readable medium comprising computer-readable program code that, in response to execution by at least one processing circuitry, causes an apparatus to perform the method of any of clauses 22 to 28.

Clause 23. A computer-readable storage medium comprising computer-readable program code that, in response to execution by at least one processing circuitry, causes an apparatus to perform the method of any of clauses 11 to 15.

Clause 24. A computer program comprising computer-readable program code that, in response to execution by at least one processing circuitry, causes an apparatus to perform the method of any of clauses 11 to 15.

Clause 25. An apparatus comprising: at least one memory configured to store computer-readable program code; and at least one processing circuitry configured to access the at least one memory, and execute the computer-readable program code to cause the apparatus to at least: collect operational information at a network including to a first transmission-reception point (TRP) and a second TRP, the operational information including information relating to one or more of the first TRP, the second TRP, or a user equipment connected to both the first TRP and the second TRP, the user equipment having a first downlink (DL) connection and a second DL connection with respectively the first TRP and the second TRP, but an uplink (UL) connection with with the second TRP but not the first TRP; perform an evaluation of the operational information for potential UL failure at either of the first TRP or the second TRP; and make a determination, at the network, whether or not to switch the UL connection from the second TRP to the first TRP, based on the evaluation.

Clause 26. The apparatus of clause 25, wherein the operational information includes beam failure information of at least one of the first TRP or the second TRP

Clause 27. The apparatus of clause 26, wherein the operational information also includes one or more of signal strength of at least one of the first TRP or the second TRP, location of the user equipment, speed of the user equipment, direction of travel of the user equipment, or interference in an environment of at least one of the first TRP, the second TRP or the user equipment.

Clause 28. The apparatus of any of clauses 25 to 27, wherein when the evaluation indicates the potential UL failure at the first TRP, the determination is made to not switch the UL connection.

Clause 29. The apparatus of any of clauses 25 to 28, wherein when the evaluation indicates the potential UL failure at the second TRP, the determination is made to switch the UL connection, and the at least one processing circuitry is configured to execute the computer-readable program code to cause the apparatus to further at least: switch the UL connection from the second TRP to the first TRP, based on the determination.

Clause 30. An apparatus comprising: means for collecting operational information at a network including to a first transmission-reception point (TRP) and a second TRP, the operational information including information relating to one or more of the first TRP, the second TRP, or an user equipment connected to both the first TRP and the second TRP, the user equipment having a first downlink (DL) connection and a second DL connection with respectively the first TRP and the second TRP, but an uplink (UL) connection with with the second TRP but not the first TRP; means for performing an evaluation of the operational information for potential UL failure at either of the first TRP or the second TRP; and means for making a determination, at the network, whether or not to switch the UL connection from the second TRP to the first TRP, based on the evaluation.

Clause 31. The apparatus of clause 30, wherein the operational information includes beam failure information of at least one of the first TRP or the second TRP

Clause 32. The apparatus of clause 31, wherein the operational information also includes one or more of signal strength of at least one of the first TRP or the second TRP, location of the user equipment, speed of the user equipment, direction of travel of the user equipment, or interference in an environment of at least one of the first TRP, the second TRP or the user equipment.

Clause 33. The apparatus of any of clauses 30 to 32, wherein when the evaluation indicates the potential UL failure at the first TRP, the determination is made to not switch the UL connection.

Clause 34. The apparatus of any of clauses 30 to 33, wherein when the evaluation indicates the potential UL failure at the second TRP, the determination is made to switch the UL connection, and the apparatus further comprises: switching means for switching the UL connection from the second TRP to the first TRP, based on the determination.

Clause 35. A method comprising: collecting operational information at a network including to a first transmission-reception point (TRP) and a second TRP, the operational information including information relating to one or more of the first TRP, the second TRP, or a user equipment connected to both the first TRP and the second TRP, the user equipment having a first downlink (DL) connection and a second DL connection with respectively the first TRP and the second TRP, but an uplink (UL) connection with with the second TRP but not the first TRP; performing an evaluation of the operational information for potential UL failure at either of the first TRP or the second TRP; and making a determination, at the network, whether or not to switch the UL connection from the second TRP to the first TRP, based on the evaluation.

Clause 36. The method of clause 35, wherein the operational information includes beam failure information of at least one of the first TRP or the second TRP

Clause 37. The method of clause 36, wherein the operational information also includes one or more of signal strength of at least one of the first TRP or the second TRP, location of the user equipment, speed of the user equipment, direction of travel of the user equipment, or interference in an environment of at least one of the first TRP, the second TRP or the user equipment.

Clause 38. The method of any of clauses 35 to 37, wherein when the evaluation indicates the potential UL failure at the first TRP, the determination is made to not switch the UL connection.

Clause 39. The method of any of clauses 35 to 38, wherein when the evaluation indicates the potential UL failure at the second TRP, the determination is made to switch the UL connection, and the method further comprises: switching the UL connection from the second TRP to the first TRP, based on the determination.

Clause 40. A computer-readable storage medium that is non-transitory and has computer-readable program code stored therein that, in response to execution by at least one processing circuitry, causes an apparatus to at least: collect operational information at a network including to a first transmission-reception point (TRP) and a second TRP, the operational information including information relating to one or more of the first TRP, the second TRP, or a user equipment connected to both the first TRP and the second TRP, the user equipment having a first downlink (DL) connection and a second DL connection with respectively the first TRP and the second TRP, but an uplink (UL) connection with with the second TRP but not the first TRP; perform an evaluation of the operational information for potential UL failure at either of the first TRP or the second TRP; and make a determination, at the network, whether or not to switch the UL connection from the second TRP to the first TRP, based on the evaluation.

Clause 41. The computer-readable storage medium of clause 40, wherein the operational information includes beam failure information of at least one of the first TRP or the second TRP

Clause 42. The computer-readable storage medium of clause 41, wherein the operational information also includes one or more of signal strength of at least one of the first TRP or the second TRP, location of the user equipment, speed of the user equipment, direction of travel of the user equipment, or interference in an environment of at least one of the first TRP, the second TRP or the user equipment.

Clause 43. The computer-readable storage medium of any of clauses 40 to 42, wherein when the evaluation indicates the potential UL failure at the first TRP, the determination is made to not switch the UL connection.

Clause 44. The computer-readable storage medium of any of clauses 40 to 43, wherein when the evaluation indicates the potential UL failure at the second TRP, the determination is made to switch the UL connection, and the computer-readable storage medium has further computer-readable program code stored therein that, in response to execution by the at least one processing circuitry, causes the apparatus to further at least: switch the UL connection from the second TRP to the first TRP, based on the determination.

Clause 45. An apparatus comprising means for performing the method of any of clauses 35 to 39.

Clause 46. A computer-readable medium comprising computer-readable program code that, in response to execution by at least one processing circuitry, causes an apparatus to perform the method of any of clauses 35 to 39.

Clause 47. A computer-readable storage medium comprising computer-readable program code that, in response to execution by at least one processing circuitry, causes an apparatus to perform the method of any of clauses 35 to 39.

Clause 48. A computer program comprising computer-readable program code that, in response to execution by at least one processing circuitry, causes an apparatus to perform the method of any of clauses 35 to 39.

Clause 49. An apparatus comprising: means for detecting a beam failure at an user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the second DL connection with the second TRP; means for performing an evaluation of a UL condition of the first TRP; means for making a determination to switch the UL connection from the second TRP to the first TRP or a third TRP, based on the evaluation; and means for switching the UL connection from the second TRP to the first TRP or the third TRP, based on the determination.

Clause 50. The apparatus of clause 49, wherein when the determination is made to switch the UL connection from the second TRP to the first TRP, the apparatus further comprises: means for making a second determination whether or not the user equipment is able to determine a timing adjustment of the first TRP; and the means for switching the UL connection includes means for switching the UL connection from the second TRP to the first TRP based on the second determination.

Clause 51. The apparatus of clause 50, wherein when the second determination is made that the user equipment is able to determine the timing adjustment of the first TRP, the apparatus further comprises: means for determining the timing adjustment of the first TRP; and using the timing adjustment, the means for switching the UL connection from the second TRP to the first TRP includes means for signaling the network, from the user equipment via the first TRP, to request switching the UL connection to the first TRP.

Clause 52. The apparatus of clause 50 or clause 51, wherein when the second determination is made that the user equipment is unable to determine the timing adjustment, the means for switching the UL connection from the second TRP to the first TRP includes: means for signaling the network, from the user equipment via a preamble transmission to the first TRP, to obtain the timing adjustment; and using the timing adjustment, means for signaling the network, from the user equipment via the first TRP, to request switching the UL connection to the first TRP.

Clause 53. The apparatus of any of clauses 49 to 52, wherein when the determination is made to switch the UL connection from the second TRP to the third TRP, the apparatus further comprises: means for signaling the network, from the user equipment via a preamble transmission to the third TRP, to obtain a timing adjustment of the third TRP; and using the timing adjustment, means for signaling the network, from the user equipment via the third TRP, to request switching the UL connection to the third TRP.

Clause 54. An apparatus comprising: at least one memory configured to store computer-readable program code; and at least one processing circuitry configured to access the at least one memory, and execute the computer-readable program code to cause the apparatus to at least: detect a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the second DL connection with the second TRP; perform an evaluation of a UL condition of the first TRP; make a determination to switch the UL connection from the second TRP to the first TRP or a third TRP, based on the evaluation; and switch the UL connection from the second TRP to the first TRP or the third TRP, based on the determination.

Clause 55. The apparatus of clause 54, wherein when the determination is made to switch the UL connection from the second TRP to the first TRP, the at least one processing circuitry is configured to execute the computer-readable program code to cause the apparatus to further at least: make a second determination whether or not the user equipment is able to determine a timing adjustment of the first TRP; and switch the UL connection includes switching the UL connection from the second TRP to the first TRP based on the second determination.

Clause 56. The apparatus of clause 55, wherein when the second determination is made that the user equipment is able to determine the timing adjustment of the first TRP, the at least one processing circuitry is configured to execute the computer-readable program code to cause the apparatus to further at least: determine the timing adjustment of the first TRP; and using the timing adjustment, switch the UL connection from the second TRP to the first TRP includes signaling the network, from the user equipment via the first TRP, to request switching the UL connection to the first TRP.

Clause 57. The apparatus of clause 55 or clause 56, wherein when the second determination is made that the user equipment is unable to determine the timing adjustment, switching the UL connection from the second TRP to the first TRP includes: signal the network, from the user equipment via a preamble transmission to the first TRP, to obtain the timing adjustment; and using the timing adjustment, signal the network, from the user equipment via the first TRP, to request switching the UL connection to the first TRP.

Clause 58. The apparatus of any of clauses 54 to 57, wherein when the determination is made to switch the UL connection from the second TRP to the third TRP, the at least one processing circuitry is configured to execute the computer-readable program code to cause the apparatus to further at least: signal the network, from the user equipment via a preamble transmission to the third TRP, to obtain a timing adjustment of the third TRP; and using the timing adjustment, signal the network, from the user equipment via the third TRP, to request switching the UL connection to the third TRP.

Clause 59. A method comprising: detecting a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the second DL connection with the second TRP; performing an evaluation of a UL condition of the first TRP; making a determination to switch the UL connection from the second TRP to the first TRP or a third TRP, based on the evaluation; and switching the UL connection from the second TRP to the first TRP or the third TRP, based on the determination.

Clause 60. The method of clause 59, wherein when the determination is made to switch the UL connection from the second TRP to the first TRP, the method further comprises: making a second determination whether or not the user equipment is able to determine a timing adjustment of the first TRP; and switching the UL connection includes switching the UL connection from the second TRP to the first TRP based on the second determination.

Clause 61. The method of clause 60, wherein when the second determination is made that the user equipment is able to determine the timing adjustment of the first TRP, the method further comprises: determining the timing adjustment of the first TRP; and using the timing adjustment, switching the UL connection from the second TRP to the first TRP includes signaling the network, from the user equipment via the first TRP, to request switching the UL connection to the first TRP.

Clause 62. The method of clause 60 or clause 61, wherein when the second determination is made that the user equipment is unable to determine the timing adjustment, switching the UL connection from the second TRP to the first TRP includes: signaling the network, from the user equipment via a preamble transmission to the first TRP, to obtain the timing adjustment; and using the timing adjustment, signaling the network, from the user equipment via the first TRP, to request switching the UL connection to the first TRP.

Clause 63. The method of any of clauses 59 to 62, wherein when the determination is made to switch the UL connection from the second TRP to the third TRP, the method further comprises: signaling the network, from the user equipment via a preamble transmission to the third TRP, to obtain a timing adjustment of the third TRP; and using the timing adjustment, signaling the network, from the user equipment via the third TRP, to request switching the UL connection to the third TRP.

Clause 64. A computer-readable storage medium that is non-transitory and has computer-readable program code stored therein that, in response to execution by at least one processing circuitry, causes an apparatus to at least: detect a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the second DL connection with the second TRP; perform an evaluation of a UL condition of the first TRP; make a determination to switch the UL connection from the second TRP to the first TRP or a third TRP, based on the evaluation; and switch the UL connection from the second TRP to the first TRP or the third TRP, based on the determination.

Clause 65. The computer-readable storage medium of clause 64, wherein when the determination is made to switch the UL connection from the second TRP to the first TRP, the computer-readable storage medium has further computer-readable program code stored therein that, in response to execution by the at least one processing circuitry, causes the apparatus to further at least: make a second determination whether or not the user equipment is able to determine a timing adjustment of the first TRP; and switch the UL connection includes switching the UL connection from the second TRP to the first TRP based on the second determination.

Clause 66. The computer-readable storage medium of clause 65, wherein when the second determination is made that the user equipment is able to determine the timing adjustment of the first TRP, the computer-readable storage medium has further computer-readable program code stored therein that, in response to execution by the at least one processing circuitry, causes the apparatus to further at least: determine the timing adjustment of the first TRP; and using the timing adjustment, switch the UL connection from the second TRP to the first TRP includes signaling the network, from the user equipment via the first TRP, to request switching the UL connection to the first TRP.

Clause 67. The computer-readable storage medium of clause 65 or clause 66, wherein when the second determination is made that the user equipment is unable to determine the timing adjustment, switching the UL connection from the second TRP to the first TRP includes: signal the network, from the user equipment via a preamble transmission to the first TRP, to obtain the timing adjustment; and using the timing adjustment, signal the network, from the user equipment via the first TRP, to request switching the UL connection to the first TRP.

Clause 68. The computer-readable storage medium of any of clauses 64 to 67, wherein when the determination is made to switch the UL connection from the second TRP to the third TRP, the computer-readable storage medium has further computer-readable program code stored therein that, in response to execution by the at least one processing circuitry, causes the apparatus to further at least: signal the network, from the user equipment via a preamble transmission to the third TRP, to obtain a timing adjustment of the third TRP; and using the timing adjustment, signal the network, from the user equipment via the third TRP, to request switching the UL connection to the third TRP.

Clause 69. An apparatus comprising means for performing the method of any of clauses 59 to 63.

Clause 70. A computer-readable medium comprising computer-readable program code that, in response to execution by at least one processing circuitry, causes an apparatus to perform the method of any of clauses 59 to 63.

Clause 71. A computer-readable storage medium comprising computer-readable program code that, in response to execution by at least one processing circuitry, causes an apparatus to perform the method of any of clauses 59 to 63.

Clause 72. A computer program comprising computer-readable program code that, in response to execution by at least one processing circuitry, causes an apparatus to perform the method of any of clauses 59 to 63.

Clause 73. An apparatus comprising: at least one memory configured to store computer-readable program code; and at least one processing circuitry configured to access the at least one memory, and execute the computer-readable program code to cause the apparatus to at least: detect a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the first DL connection with the first TRP; evaluate a difference in propagation delay between the first TRP and the second TRP; make a determination whether to perform a beam recovery procedure to recover the first DL connection, with the first TRP or through the UL connection with the second TRP, based on the difference in propagation delay; and perform the beam recovery procedure based on the determination.

Clause 74. The apparatus of clause 73, wherein the determination is made based on the difference in propagation delay and a threshold difference, and the threshold difference is a length of a guard period between units of data transmitted by the first TRP and the second TRP.

Clause 75. The apparatus of clause 73 or clause 74, wherein when the difference in propagation delay is less than a threshold difference, the determination is made to perform the beam recovery procedure with the first TRP.

Clause 76. The apparatus of any of clauses 73 to 75, wherein when the difference in propagation delay is greater than a threshold difference, the determination is made to perform the beam recovery procedure through the UL connection with the second TRP.

Clause 77. The apparatus of clause 76, wherein performing the beam recovery procedure through the UL connection with the second TRP includes: signal the network, from the user equipment via the UL connection with the second TRP, to indicate a candidate DL beam of the first TRP for recovery of the first DL connection; and receive a message at the user equipment, from the network via the UL connection with the second TRP, to instruct the user equipment to switch to the candidate DL beam, or acknowledge a switch to the candidate DL beam.

Clause 78. An apparatus comprising: means for detecting a beam failure at an user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the first DL connection with the first TRP; means for evaluating a difference in propagation delay between the first TRP and the second TRP; means for making a determination whether to perform a beam recovery procedure to recover the first DL connection, with the first TRP or through the UL connection with the second TRP, based on the difference in propagation delay; and means for performing the beam recovery procedure based on the determination.

Clause 79. The apparatus of clause 78, wherein the determination is made based on the difference in propagation delay and a threshold difference, and the threshold difference is a length of a guard period between units of data transmitted by the first TRP and the second TRP.

Clause 80. The apparatus of clause 78 or clause 79, wherein when the difference in propagation delay is less than a threshold difference, the determination is made to perform the beam recovery procedure with the first TRP.

Clause 81. The apparatus of any of clauses 78 to 80, wherein when the difference in propagation delay is greater than a threshold difference, the determination is made to perform the beam recovery procedure through the UL connection with the second TRP.

Clause 82. The apparatus of clause 81, wherein the means for performing the beam recovery procedure through the UL connection with the second TRP includes: means for signaling the network, from the user equipment via the UL connection with the second TRP, to indicate a candidate DL beam of the first TRP for recovery of the first DL connection; and means for receiving a message at the user equipment, from the network via the UL connection with the second TRP, to instruct the user equipment to switch to the candidate DL beam, or acknowledge a switch to the candidate DL beam.

Clause 83. A method comprising: detecting a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the first DL connection with the first TRP; evaluating a difference in propagation delay between the first TRP and the second TRP; making a determination whether to perform a beam recovery procedure to recover the first DL connection, with the first TRP or through the UL connection with the second TRP, based on the difference in propagation delay; and performing the beam recovery procedure based on the determination.

Clause 84. The method of clause 83, wherein the determination is made based on the difference in propagation delay and a threshold difference, and the threshold difference is a length of a guard period between units of data transmitted by the first TRP and the second TRP.

Clause 85. The method of clause 83 or clause 84, wherein when the difference in propagation delay is less than a threshold difference, the determination is made to perform the beam recovery procedure with the first TRP.

Clause 86. The method of any of clauses 83 to 85, wherein when the difference in propagation delay is greater than a threshold difference, the determination is made to perform the beam recovery procedure through the UL connection with the second TRP.

Clause 87. The method of clause 86, wherein performing the beam recovery procedure through the UL connection with the second TRP includes: signaling the network, from the user equipment via the UL connection with the second TRP, to indicate a candidate DL beam of the first TRP for recovery of the first DL connection; and receiving a message at the user equipment, from the network via the UL connection with the second TRP, to instruct the user equipment to switch to the candidate DL beam, or acknowledge a switch to the candidate DL beam.

Clause 88. A computer-readable storage medium that is non-transitory and has computer-readable program code stored therein that, in response to execution by at least one processing circuitry, causes an apparatus to at least: detect a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the first DL connection with the first TRP; evaluate a difference in propagation delay between the first TRP and the second TRP; make a determination whether to perform a beam recovery procedure to recover the first DL connection, with the first TRP or through the UL connection with the second TRP, based on the difference in propagation delay; and perform the beam recovery procedure based on the determination.

Clause 89. The computer-readable storage medium of clause 88, wherein the determination is made based on the difference in propagation delay and a threshold difference, and the threshold difference is a length of a guard period between units of data transmitted by the first TRP and the second TRP.

Clause 90. The computer-readable storage medium of clause 88 or clause 89, wherein when the difference in propagation delay is less than a threshold difference, the determination is made to perform the beam recovery procedure with the first TRP.

Clause 91. The computer-readable storage medium of any of clauses 88 to 90, wherein when the difference in propagation delay is greater than a threshold difference, the determination is made to perform the beam recovery procedure through the UL connection with the second TRP.

Clause 92. The computer-readable storage medium of clause 91, wherein performing the beam recovery procedure through the UL connection with the second TRP includes: signal the network, from the user equipment via the UL connection with the second TRP, to indicate a candidate DL beam of the first TRP for recovery of the first DL connection; and receive a message at the user equipment, from the network via the UL connection with the second TRP, to instruct the user equipment to switch to the candidate DL beam, or acknowledge a switch to the candidate DL beam.

Clause 93. An apparatus comprising means for performing the method of any of clauses 83 to 87.

Clause 94. A computer-readable medium comprising computer-readable program code that, in response to execution by at least one processing circuitry, causes an apparatus to perform the method of any of clauses 83 to 87.

Clause 95. A computer-readable storage medium comprising computer-readable program code that, in response to execution by at least one processing circuitry, causes an apparatus to perform the method of any of clauses 83 to 87.

Clause 96. A computer program comprising computer-readable program code that, in response to execution by at least one processing circuitry, causes an apparatus to perform the method of any of clauses 83 to 87.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising:
at least one memory configured to store computer-readable program code; and
at least one processing circuitry configured to access the at least one memory, and execute the computer-readable program code to cause the apparatus to at least to perform the following:
monitoring a radio link quality at a user equipment connected to both a first transmission-reception point (TRP) and a second TRP of a network, the user equipment having a first downlink (DL) connection and a second DL connection with respectively the first TRP and the second TRP, but an uplink (UL) connection with with the second TRP but not the first TRP, the radio link quality monitored being of the second DL connection with the second TRP;
identifying a condition for switching the UL connection, based on at least the radio link quality of the second DL connection; and
switching the UL connection from the second TRP to the first TRP, based on the determination.

2. The apparatus of claim 1, configured to perform:
signaling the network, from the user equipment via the second TRP, of user equipment capabilities including a capability of switching between TRPs; and
receiving radio resource control signaling at the user equipment, from the network via the second TRP, to enable the capability at the user equipment.

3. The apparatus of claim 1, wherein monitoring the radio link quality includes monitoring a first radio link quality of the first TRP, and a second radio link quality of the second TRP, and
wherein the condition is a degradation in the second DL connection, and the condition is identified based on the first radio link quality and the second radio link quality.

4. The apparatus of claim 1, wherein the condition that is identified is a condition for switching at least one of a UL control channel or a UL shared channel of the UL connection, and switching the UL connection includes switching the at least one of the UL control channel or the UL shared channel.

5. The apparatus of claim 1, wherein switching the UL connection includes signaling the network, from the user equipment via the second TRP, to request switching the UL connection to the first TRP.

6. An apparatus comprising:
at least one memory configured to store computer-readable program code; and
at least one processing circuitry configured to access the at least one memory, and execute the computer-readable program code to cause the apparatus to at least to perform the following:
collecting operational information at a network including to a first transmission-reception point (TRP) and a second TRP, the operational information including information relating to one or more of the first TRP, the second TRP, or a user equipment connected to both the first TRP and the second TRP, the user equipment having a first downlink (DL) connection and a second DL connection with respectively the first TRP and the second TRP, but an uplink (UL) connection with with the second TRP but not the first TRP;
performing an evaluation of the operational information for potential UL failure at either of the first TRP or the second TRP; and
making a determination, at the network, whether or not to switch the UL connection from the second TRP to the first TRP, based on the evaluation.

7. The apparatus of claim 6, wherein the operational information includes beam failure information of at least one of the first TRP or the second TRP.

8. The apparatus of claim 7, wherein the operational information also includes one or more of signal strength of at least one of the first TRP or the second TRP, location of the user equipment, speed of the user equipment, direction of travel of the user equipment, or interference in an environment of at least one of the first TRP, the second TRP or the user equipment.

9. The apparatus of claim 6, wherein when the evaluation indicates the potential UL failure at the first TRP, the determination is made to not switch the UL connection.

10. The apparatus of claim 6, wherein when the evaluation indicates the potential UL failure at the second TRP, the determination is made to switch the UL connection, and the method further comprises:
switching the UL connection from the second TRP to the first TRP, based on the determination.

11. An apparatus comprising:
at least one memory configured to store computer-readable program code; and
at least one processing circuitry configured to access the at least one memory, and execute the computer-readable program code to cause the apparatus to at least to perform the following:
detecting a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the second DL connection with the second TRP;
performing an evaluation of a UL condition of the first TRP;
making a determination to switch the UL connection from the second TRP to the first TRP or a third TRP, based on the evaluation; and
switching the UL connection from the second TRP to the first TRP or the third TRP, based on the determination.

12. The apparatus of claim 11, wherein when the determination is made to switch the UL connection from the second TRP to the first TRP, and the apparatus is further configured to perform:
making a second determination whether or not the user equipment is able to determine a timing adjustment of the first TRP; and
switching the UL connection includes switching the UL connection from the second TRP to the first TRP based on the second determination.

13. The apparatus of claim 12, wherein when the second determination is made that the user equipment is able to determine the timing adjustment of the first TRP, the apparatus is further configured to perform:
determining the timing adjustment of the first TRP; and using the timing adjustment,
switching the UL connection from the second TRP to the first TRP includes signaling the network, from the user equipment via the first TRP, to request switching the UL connection to the first TRP.

14. The apparatus of claim 12, wherein when the second determination is made that the user equipment is unable to determine the timing adjustment, switching the UL connection from the second TRP to the first TRP includes:
signaling the network, from the user equipment via a preamble transmission to the first TRP, to obtain the timing adjustment; and using the timing adjustment, signaling the network, from the user equipment via the first TRP, to request switching the UL connection to the first TRP.

15. The apparatus of claim 11, wherein when the determination is made to switch the UL connection from the second TRP to the third TRP, the apparatus further configured to perform:
signaling the network, from the user equipment via a preamble transmission to the third TRP, to obtain a timing adjustment of the third TRP; and using the timing adjustment,
signaling the network, from the user equipment via the third TRP, to request switching the UL connection to the third TRP.

16. An apparatus comprising:
at least one memory configured to store computer-readable program code; and
at least one processing circuitry configured to access the at least one memory, and execute the computer-readable program code to cause the apparatus to at least to perform the following:
detecting a beam failure at a user equipment connected to both a first transmission-reception point (TRP) and a second TRP of a network, the user equipment having a first downlink (DL) connection and a second DL connection with respectively the first TRP and the second TRP, but a UL connection with with the second TRP but not the first TRP, the beam failure being of the first DL connection with the first TRP;
evaluating a difference in propagation delay between the first TRP and the second TRP;
making a determination whether to perform a beam recovery procedure to recover the first DL connection, with the first TRP or through the UL connection with the second TRP, based on the difference in propagation delay; and
performing the beam recovery procedure based on the determination.

17. The apparatus of claim 16, wherein the determination is made based on the difference in propagation delay and a threshold difference, and the threshold difference is a length of a guard period between units of data transmitted by the first TRP and the second TRP.

18. The apparatus of claim 16, wherein when the difference in propagation delay is less than a threshold difference, the determination is made to perform the beam recovery procedure with the first TRP.

19. The apparatus of claim 16, wherein when the difference in propagation delay is greater than a threshold difference, the determination is made to perform the beam recovery procedure through the UL connection with the second TRP.

20. The apparatus of claim 19, wherein performing the beam recovery procedure through the UL connection with the second TRP includes:
signaling the network, from the user equipment via the UL connection with the second TRP, to indicate a candidate DL beam of the first TRP for recovery of the first DL connection; and
receiving a message at the user equipment, from the network via the UL connection with the second TRP, to instruct the user equipment to switch to the candidate DL beam, or acknowledge a switch to the candidate DL beam.
